(19) United States
(12) Patent Application Publication
(10) Pub. No.: US 2026/0077559 A1
(43) Pub. Date: Mar. 19, 2026

(54) FILAMENT FEEDING DEVICES AND METHODS FOR FUSED DEPOSITION MODELING (FDM) NUMERICALLY CONTROLLED 3D PRINTERS

(71) Applicant: CHENGDU AIRCRAFT INDUSTRIAL (GROUP) CO., LTD., Chengdu (CN)

(72) Inventors: Chen WANG, Chengdu (CN); Xiangbo XU, Chengdu (CN); Tao YANG, Chengdu (CN); Wenqiang ZHOU, Chengdu (CN); Jian SHE, Chengdu (CN); Yu ZHANG, Chengdu (CN); Jixu YIN, Chengdu (CN); Shuai ZHAO, Chengdu (CN)

(73) Assignee: CHENGDU AIRCRAFT INDUSTRIAL (GROUP) CO., LTD., Chengdu (CN)

(21) Appl. No.: 19/401,437

(22) Filed: Nov. 26, 2025

Related U.S. Application Data
(63) Continuation of application No. PCT/CN2023/130931, filed on Nov. 10, 2023.

(30) Foreign Application Priority Data
Jun. 6, 2023 (CN) 202310660930.9

(51) Int. Cl. B29C 64/321; B29C 64/118; B33Y 10/00; B33Y 40/00

(52) U.S. Cl. CPC B29C 64/321; B29C 64/118; B33Y 10/00; B33Y 40/00

(57) ABSTRACT

A filament feeding device for an FDM numerically controlled 3D printer is provided. The device comprises: a filament feeding assembly, configured to expand and contract in a radial direction of the filament feeding assembly to grip and release a filament passing axially through the filament feeding assembly; a guide assembly, provided with a guide channel along an axial direction of the guide assembly, the filament feeding assembly being movably provided within the guide channel, and during movement of the filament feeding assembly along the guide assembly, the guide channel is configured to apply a radial pressure to the filament feeding assembly; a pushing assembly and a feed gear, wherein the pushing assembly is configured to push the filament feeding assembly to move along the guide channel so as to deliver the filament to the feed gear, and the feed gear is configured to convey the filament to a printing nozzle.

### CROSS-REFERENCE TO RELATED APPLICATIONS

This application is a Continuation of International Application No. PCT/CN2023/130931, filed on Nov. 10, 2023, which claims priority to Chinese Patent Application No. 202310660930.9, filed on Jun. 6, 2023, the entire contents of each of which are hereby incorporated by reference.

### TECHNICAL FIELD

The present disclosure relates to the field of three-dimensional (3D) printing technology, and in particular, to filament feeding devices and methods for Fused Deposition Modeling (FDM) numerically controlled 3D printers.

### BACKGROUND

Fused Deposition Modeling (FDM) numerically controlled 3D printing technology, i.e., Fused Deposition Modeling, is a type of additive manufacturing process. Its working principle involves feeding a 3D printing filament through an extrusion mechanism into a heating block maintained at a temperature between 200° C. and 500° C. Under the effects of high temperature and high pressure, the filament with a diameter of 1.75 mm to 3.0 mm is melted and extruded into a printing filament with a diameter of 0.4 mm to 0.8 mm. Subsequently, through trajectory movements of an X feed axis, a Y feed axis, and a Z feed axis, the printed filament is selectively deposited layer by layer along a predetermined path to construct and form an object. During the automatic filament retraction and feeding operations, the printing equipment may experience a phenomenon known as idling (or slipping), which may lead to discontinuous filament feeding and consequently result in print failure.

Therefore, a filament feeding device and a method for an FDM numerically controlled 3D printer are provided to ensure continuity of filament retraction and feeding.

### SUMMARY

One or more embodiments of the present disclosure provide a filament feeding device for a Fused Deposition Modeling (FDM) numerically controlled three-dimensional (3D) printer, comprising: a filament feeding assembly, configured to expand and contract in a radial direction of the filament feeding assembly to grip and release a filament passing axially through the filament feeding assembly; a guide assembly, wherein the guide assembly is provided with a guide channel along an axial direction of the guide assembly, the filament feeding assembly is movably provided within the guide channel, and during movement of the filament feeding assembly along the guide assembly, the guide channel is configured to apply a radial pressure to the filament feeding assembly; a pushing assembly and a feed gear, wherein the pushing assembly is configured to push the filament feeding assembly to move along the guide channel so as to deliver the filament to the feed gear, and the feed gear is configured to convey the filament to a printing nozzle.

One or more embodiments of the present disclosure provide a fully automatic filament feeding method for a Fused Deposition Modeling (FDM) numerically controlled three-dimensional (3D) printer, being based on the filament feeding device for the FDM numerically controlled 3D printer provided in one or more embodiments of the present disclosure. The method comprises: executing, by a system, a zero reset operation for a workpiece coordinate system and returning a filament feeding axis to a reference point; controlling the pushing assembly of the filament feeding device to push the filament feeding assembly to move and grip the filament, and feeding the filament toward the feed gear.

### BRIEF DESCRIPTION OF THE DRAWINGS

The present disclosure is further described by way of exemplary embodiments. These exemplary embodiments are described in detail with reference to the accompanying drawings. These embodiments are not limiting. In these embodiments, the same reference numerals denote the same structures, wherein:

FIG. 1 is a schematic diagram illustrating a state of an “idling phenomenon” occurring in a conventional FDM numerically controlled 3D printer according to some embodiments of the present disclosure;

FIG. 2 is a schematic diagram illustrating a filament feeding device for an FDM numerically controlled 3D printer according to some embodiments of the present disclosure;

FIG. 3 is an exploded structural diagram illustrating a filament feeding device for an FDM numerically controlled 3D printer according to some embodiments of the present disclosure;

FIG. 4 is a schematic diagram illustrating a state of a filament feeding device for an FDM numerically controlled 3D printer before filament feeding according to some embodiments of the present disclosure; and

FIG. 5 is a schematic diagram illustrating a state of a filament feeding device for an FDM numerically controlled 3D printer after completing filament feeding according to some embodiments of the present disclosure.

Reference numerals in the drawings: 1—filament feeding assembly, 101—feed tube, 102—contraction portion, 103—receiving boss, 2—pushing assembly, 201—automatic telescoping member, 202—pressure—bearing cover, 3—guide assembly, 301—guide barrel, 302—guide channel, 303—guide sleeve, 304—base, 305—damping adjustment ring, 306—elastic compression member, 4—feed gear, 5—print head.

### DETAILED DESCRIPTION

In order to more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose.

As indicated in the specification and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

In the present disclosure, unless expressly specified and defined otherwise, terms such as “connected,” “fixed,” or the like should be interpreted broadly. For example, “fixed” may mean a permanent connection, a detachable connection, or being formed integrally; it may be a mechanical connection, an electrical connection, or a direct connection, or it may be an indirect connection through an intermediary medium. It may signify the internal communication between two elements or the interactional relationship between two elements, unless expressly defined otherwise. A person of ordinary skill in the art may understand the specific meanings of these terms in the present disclosure based on the specific context.

Furthermore, if the description of the embodiments in the present disclosure involves descriptions such as “first” and “second,” then these descriptions are for descriptive purposes only and are not to be construed as indicating or implying relative importance or implicitly specifying the quantity of the indicated technical features. Thus, features defined by “first” or “second” may explicitly or implicitly include at least one such feature. Additionally, the meaning of “and/or” appearing throughout the text includes three parallel options. Taking “A and/or B” as an example, it includes Scenario A, or Scenario B, or the scenario where both A and B are satisfied. Moreover, the technical solutions in the various embodiments may be combined with each other, provided that such combination can be implemented by a person of ordinary skill in the art. When the combination of technical solutions results in mutual contradiction or impossibility of implementation, it shall be considered that such a combination does not exist and is not within the scope of protection sought by the present disclosure.

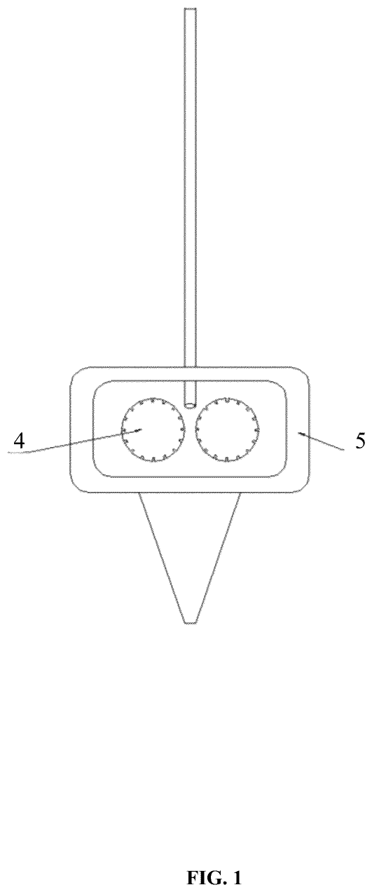

FIG. 1 is a schematic diagram illustrating a state of an “idling phenomenon” occurring in a conventional FDM numerically controlled 3D printer according to some embodiments of the present disclosure.

In some embodiments, Fused Deposition Modeling (FDM) numerically controlled 3D printing technology, i.e., Fused Deposition Modeling, is a type of additive manufacturing process. Its working principle involves feeding a 3D printing filament through an extrusion mechanism into a heating block maintained at a temperature between 200° C. and 500° C. Under the effects of high temperature and high pressure, a filament with a diameter of 1.75 mm to 3.0 mm is melted and extruded into a printing filament with a diameter of 0.4 mm to 0.8 mm. The printer can selectively deposit the melted material layer by layer along a predetermined path through the trajectory movements of its various feed axes to construct an object.

By way of example, the feed axes include an X-axis, a Y-axis, and a Z-axis. The filament feeding device may achieve trajectory movement within three-dimensional space via the X, Y, and Z axes. The filament may be fed into the heating block via a filament feeding axis. Depending on the size of the part, the length of the filament fed may range from several meters to hundreds of meters.

In commonly available 3D printing equipment, the X, Y, and Z feed axes typically utilize stepper motors, whereas the filament feeding axis in numerically controlled 3D printer employs a servo motor. The operational distinction lies in the fact that a stepper motor operates primarily by receiving control signals without providing feedback, while a servo motor not only receives control signals but also provides positional feedback during operation. Consequently, due to this difference in performance characteristics, an encoder of the servo motor provides real-time feedback of a pulse count during prolonged continuous operation. Simultaneously, because an internal counter of a numerical control system has a fixed capacity (e.g., −32,767 to +32,767), the pulse count fed back by the encoder of the servo motor gradually accumulates in the counter. When the pulse count exceeds the counter's maximum capacity, the numerical control system generates an “axis position overflow alarm.” Upon the occurrence of the “axis position overflow alarm”, the printing process cannot continue. To resolve the “axis position overflow alarm,” the numerical control system must perform a zero reset operation to clear the counter's value each time the filament feed length by the servo motor reaches a specified value, thereby resetting the count for a next round. However, when the servo motor executes the zero reset operation based on a numerical control command, the 3D printing filament retracts to a feeding inlet. At this time, the filament is disengaged from a feed gear. Consequently, when the servo motor executes a next filament feeding command, the feed gear fails to effectively grip a leading end of the filament due to its prior retraction, resulting in the “idling phenomenon” as illustrated in FIG. 1. Addressing this issue is critical for manufacturing large-scale parts in fields such as aviation via FDM numerically controlled 3D printing, which inherently requires continuous, long-distance filament feeding. Failure to resolve the “idling phenomenon” occurring during the automatic retraction and feeding rounds may prevent sustained filament delivery, thereby hindering the feasibility of printing large-scale aviation parts.

Therefore, a filament feeding device and a fully automatic filament feeding method for an FDM numerically controlled 3D printer are provided.

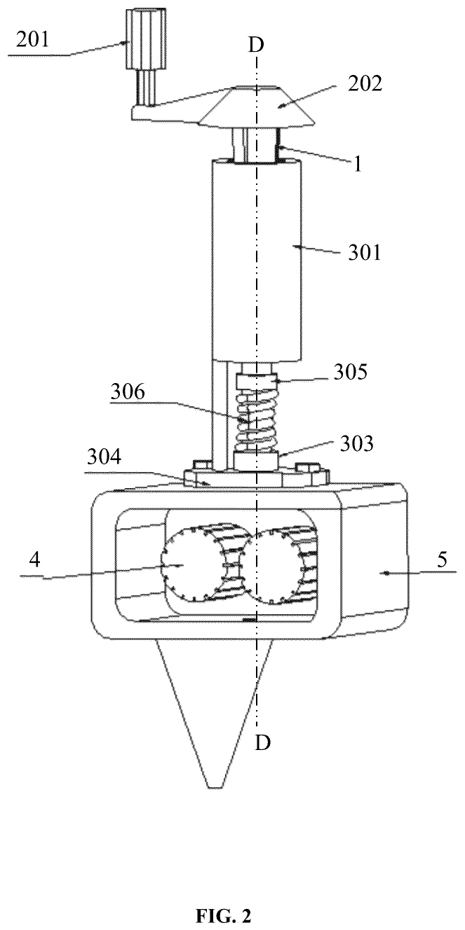

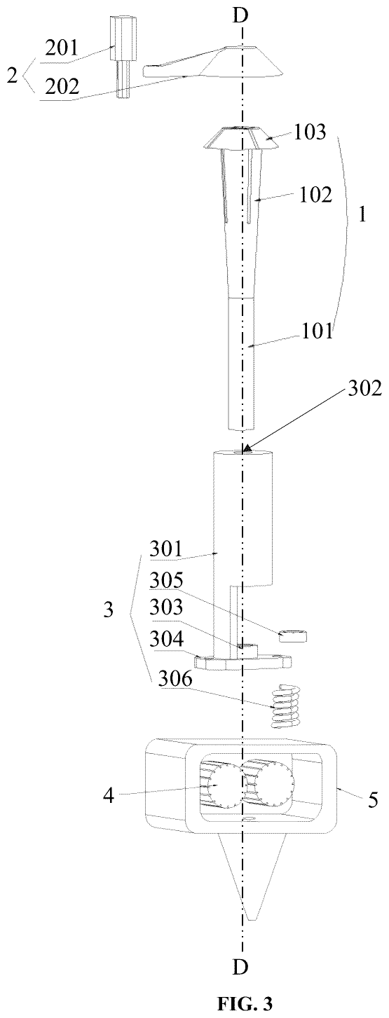

FIG. 2 is a schematic diagram illustrating a filament feeding device for an FDM numerically controlled 3D printer according to some embodiments of the present disclosure. FIG. 3 is an exploded structural diagram illustrating a filament feeding device for an FDM numerically controlled 3D printer according to some embodiments of the present disclosure.

In some embodiments, as shown in FIG. 2 and FIG. 3, the filament feeding device for an FDM numerically controlled 3D printer (hereinafter referred to as the filament feeding device) includes a filament feeding assembly 1, a guide assembly 3, a pushing assembly 2, and a feed gear 4. The filament feeding assembly 1 is configured to expand and contract in a radial direction of the filament feeding assembly 1 to grip and release a filament passing axially through the filament feeding assembly 1. The guide assembly 3 is provided with a guide channel 302 along an axial direction of the guide assembly 3. The filament feeding assembly 1 is movably provided within the guide channel 302, and during movement of the filament feeding assembly 1 along the guide assembly 3, the guide channel 302 is configured to apply a radial pressure to the filament feeding assembly 1. The pushing assembly 2 is configured to push the filament feeding assembly 1 to move along the guide channel 302 so as to deliver the filament to the feed gear 4. The feed gear 4 is configured to convey the filament to a printing nozzle.

The filament feeding assembly 1 is configured to deliver the filament to the feed gear 4 or the printing nozzle. In some embodiments, the filament feeding assembly 1 is arranged in the guide channel 302 of a guide barrel 301. A top end of the filament feeding assembly 1 is plugged into a pressure-bearing cover of the pushing assembly 2, and a bottom end is plugged into a guide sleeve 303 of a base 304.

In some embodiments, the filament feeding assembly 1 may be configured to grip and deliver the filament.

The axial direction of the filament feeding assembly 1 refers to a direction (as shown by the direction of an axis D-D in FIG. 2 and FIG. 3) along a central axis of the filament feeding assembly 1, which is also a length direction of the filament feeding assembly 1. The radial direction of the filament feeding assembly 1 refers to a circumferential direction perpendicular to the central axis of the filament feeding assembly 1.

The filament refers to a wire-like thermoplastic material used for FDM numerically controlled 3D printing, e.g., Polylactic Acid (PLA), Acrylonitrile Butadiene Styrene (ABS), Polyethylene Terephthalate Glycol-modified (PETG), etc. The filament is deposited after being heated and melted to construct a three-dimensional object. In some embodiments, a diameter of the filament ranges from 1.75 mm to 3.0 mm.

In some embodiments, the filament feeding assembly 1 has an internal channel distributed along the axial direction of the filament feeding assembly 1. The filament may pass through the filament feeding assembly via the channel.

In some embodiments, the filament feeding assembly 1 may be a sleeve structure made of a flexible material (e.g., deformable rubber or silicone). The filament feeding assembly 1 may be driven to deform by an external mechanism (e.g., a cam or a lever, etc.) to grip or release the filament.

The guide assembly 3 refers to a guiding member for guiding a filament feeding direction of the filament feeding assembly 1. The guide assembly 3 can ensure that the filament feeding assembly moves along a predetermined path during the filament feeding process and assist the filament feeding assembly in achieving the gripping of the filament.

The guide channel is a cavity or channel provided inside the guide assembly along the axial direction (e.g., the direction of axis D-D). The filament feeding assembly is movably disposed within the guide channel.

In some embodiments, the guide assembly 3 is a sleeve structure. A cavity distributed inside the sleeve structure along the axial direction serves as the guide channel 302.

In some embodiments, a shape of the guide channel 302 matches a shape of an outer wall of the filament feeding assembly 1. For example, if the filament feeding assembly 1 is cylindrical, then the guide channel 302 is cylindrical. In some embodiments, an inner wall of the guide channel 302 is smooth, and a size of the guide channel 302 is slightly larger than a size of the filament feeding assembly 1, thereby ensuring that the filament feeding assembly 1 is movably disposed within the guide channel 302.

In some embodiments, the guide channel 302 is a V-shaped channel provided along the axial direction (e.g., the direction of the axis D-D). More descriptions regarding the guide channel 302 may be found in FIG. 2 to FIG. 4 and related descriptions thereof.

The radial pressure refers to a compressive force acting on the filament feeding assembly 1 in the radial direction, applied by the inner wall of the guide channel. The radial pressure may cause the filament feeding assembly 1 to contract inwardly, thereby gripping the filament passing through an interior of the filament feeding assembly 1 along the axial direction of the filament feeding assembly 1.

In some embodiments, in a direction from away from the feed gear 4 to towards the feed gear 4, a dimension (also referred to as a radial dimension) of the guide channel 302 along the radial direction gradually decreases. For example, the guide channel 302 may adopt a conical or tapered design. During the movement of the filament feeding assembly 1 along the guide assembly 3, the radial dimension of the guide channel 302 gradually decreases. When the radial dimension of the guide channel 302 is less than a radial dimension of the filament feeding assembly 1, the guide channel 302 applies the radial pressure to the filament feeding assembly 1 due to compression.

In some embodiments, the inner wall at an end of the guide channel 302 close to the feed gear 4 is made of a flexible material. During the movement of the filament feeding assembly 1 along the guide assembly 3, when the filament feeding assembly 1 moves through the guide channel 302 near the end of the feed gear 4, the inner wall of the guide channel 302 compresses the filament feeding assembly 1 to form the radial pressure, causing the filament feeding assembly 1 to grip the filament.

In some embodiments, the guide channel may also apply the radial pressure to the filament feeding assembly in various other manners. For example, a controllable radial pressure may be applied to the filament feeding assembly within the guide channel at a designated position via an adjustable mechanical gripping mechanism, such as a spring-loaded pressure plate or a hydraulic/pneumatic cylinder.

The pushing assembly 2 refers to a component for pushing the filament feeding assembly 1 to move. The pushing assembly 2 may push the filament feeding assembly 1 to move axially within the guide channel 302 so as to deliver the filament to the feed gear 4. In some embodiments, the pushing assembly 2 is located at a top of the filament feeding device and is fixedly connected (e.g., by adhesion, threaded connection, etc.) to the filament feeding assembly 1.

In some embodiments, the pushing assembly 2 may be electrically driven (e.g., by a stepper motor, a linear motor, etc.) to push the filament feeding assembly 1 to move along the axial direction within the guide channel 302.

After each zero reset operation for the workpiece coordinate system, the pushing assembly 2 may actively deliver the filament to the feed gear 4, ensuring that during the next feeding round, the feed gear 4 can re-engage with and feed the filament without experiencing “idling.”

The feed gear 4 refers to a gear-like component with a toothed surface, configured to drive the filament forward by engaging or frictionally contacting the filament.

In some embodiments, the feed gear 4 is located within a print head 5. The printing nozzle is provided on the print head 5. The print head 5 is also provided with a filament inlet corresponding to the feed gear 4. The filament inlet is arranged opposite the printing nozzle. The filament enters the print head 5 through the filament inlet and is gripped conveyed towards the printing nozzle by the feed gear 4.

The filament inlet refers to an entrance where the filament is delivered from the filament feeding assembly 1 to the feed gear 4. The print head refers to a component in the printer for heating and extruding the filament to form a printed model. The printing nozzle is a small orifice on the print head through which the molten filament is extruded.

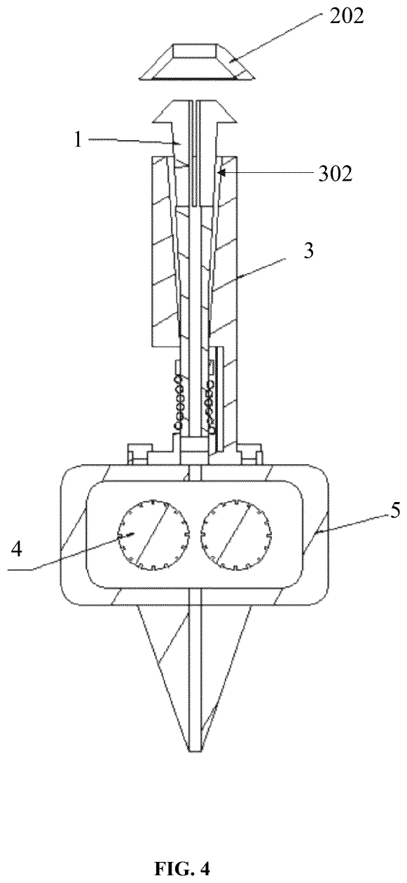

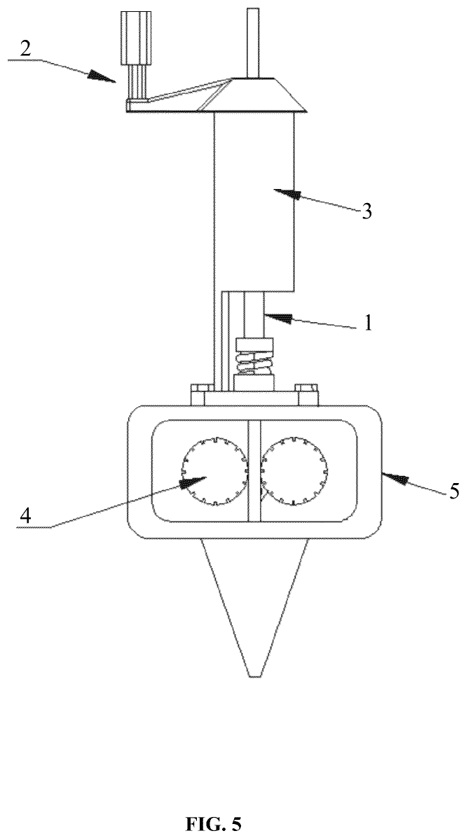

FIG. 4 is a schematic diagram illustrating a state of a filament feeding device for an FDM numerically controlled 3D printer before filament feeding according to some embodiments of the present disclosure. FIG. 5 is a schematic diagram illustrating a state of a filament feeding device for an FDM numerically controlled 3D printer after completing filament feeding according to some embodiments of the present disclosure.

In some embodiments, as shown in FIG. 4, after a previous round of the 3D printing process ends, the filament feeding assembly 1 is driven by the pushing assembly 2 to move along the guide channel 302. Under the radial pressure applied by the guide channel 302, the filament feeding assembly 1 contracts while moving, thereby gripping the filament and conveying the filament downward until the filament passes through the filament inlet and enters the feed gear 4. At the start of a new round of the 3D printing process, as shown in FIG. 5, the feed gear 4, via its gripping action, drives the filament to move toward the printing nozzle, which then extrudes the molten filament to complete the new printing round.

In some embodiments of the present disclosure, through a chain cooperation of “the filament feeding assembly-the guide channel-the pushing assembly-the feed gear,” the filament is gripped and actively fed into the feed gear after each zero reset operation. This mechanism eliminates idling, achieves a continuous, reliable, and infinitely extendable filament feeding process, significantly enhances the continuity and reliability of FDM numerically controlled 3D printing, effectively prevents printing failures, makes long-duration, continuous printing of ultra-large-scale aviation components possible, and improves production efficiency and product quality.

In some embodiments, as shown in FIG. 3, the filament feeding assembly 1 includes a feed tube 101 and a contraction portion 102 integrally formed at a terminal end of the feed tube. The contraction portion 102 is configured to, when subjected to a compressive force, grip the filament passing axially through the feed tube 101.

The feed tube 101 refers to a tubular body for guiding and conveying the filament. The terminal end of the feed tube 101 refers to an end away from the feed gear 4. In some embodiments, the feed tube 101 is located at an end of the filament feeding assembly 1 close to the feed gear 4. The feed tube 101 exhibits an elongated tubular shape distributed along the axial direction (e.g., the direction of the D-D axis).

In some embodiments, the feed tube 101 and the contraction portion 102 are integrally formed.

In some embodiments, a size of the feed tube 101 matches a size of the filament to be conveyed. In some embodiments, an inner diameter of the feed tube 101 ranges from 1.75 mm to 3.0 mm. In some embodiments, the inner diameter of the feed tube 101 ranges from 1.75 mm to 2.0 mm, 2.0 mm to 2.25 mm, 2.25 mm to 2.5 mm, or 2.5 mm to 3.0 mm.

The contraction portion 102 is a component of the filament feeding assembly 1 capable of deforming in the radial direction of the filament feeding assembly 1.

In some embodiments, the contraction portion 102 may undergo deformation along the radial direction of the filament feeding assembly 1. For example, the contraction portion 102 may include a plurality of elastic sheets distributed along the axial direction (e.g., the direction of the D-D axis). When the contraction portion 102 is compressed by an external pressure (e.g., the radial pressure from the guide channel 302), the elastic sheets bend inward and move closer to each other, causing the filament feeding assembly 1 to grip the filament. As another example, the contraction portion 102 is made of an elastic material (e.g., rubber, silicone, etc.). When the contraction portion 102 is compressed by the external pressure, the contraction portion 102 elastically deforms to contract and grip the filament. In some embodiments, the contraction portion 102 may also contract via other feasible manners.

In some embodiments, the feed tube 101 and the contraction portion 102 may be integrally formed via various manners, e.g., injection molding, 3D printing, etc.

In some embodiments, during normal printing, the filament may be smoothly fed from the feed tube 101 towards the feed gear 4. When the system performs the zero reset operation and the filament retracts to the filament inlet, the contraction portion 102, under the action of an external force, converges toward the central axis of the filament feeding assembly 1 to grip the filament. Subsequently, the pushing assembly 2 pushes the assembly forward, delivering the gripped filament into the feed gear 4, thereby preventing “idling.”In some embodiments of the present disclosure, by integrally forming the feed tube and the contraction portion, the component structure and assembly process are significantly simplified, improving production efficiency. The contraction portion grips the filament reliably when subjected to compressive force, enabling stable and dependable filament transmission. This configuration effectively avoids issues such as filament jamming and slipping, which are common in traditional split-type feeding mechanisms due to assembly tolerances, thereby significantly enhancing 3D printing accuracy and success rate, and reducing user maintenance costs.

In some embodiments, as shown in FIG. 3, the contraction portion 102 includes a plurality of petal-like segments which splay outwardly and are capable of converging centrally. That is to say, the petal-like segments are configured to expand outwardly or converge centrally in the radial direction of the filament feeding assembly 1.

The petal-like segments refer to a set of independent blade-like structures constituting the contraction portion 102. A shape of the petal-like segments may be set as required, e.g., arc-shaped, wedge-shaped, flat sheet, toothed sheet, etc. In some embodiments, the petal-like segments are made of a flexible material. In some embodiments, the plurality of petal-like segments are uniformly distributed circumferentially around the central axis of the filament feeding assembly 1. A count of the petal-like segments may be set as required, for example, 2, 3, 4, etc.

In some embodiments, the plurality of petal-like segments are in a splayed state away from the central axis (e.g., the axis D-D) of the filament feeding assembly 1 in a natural state. When compressed by the radial pressure from the guide channel 302, the petal-like segments may synchronously contract towards the central axis (e.g., the axis D-D) of the filament feeding assembly 1.

In some embodiments, in the natural state, the petal-like segments of the contraction portion 102 splay outwardly, causing an inner bore of the contraction portion 102 to be open, allowing the filament to pass through the open inner bore, thereby ensuring that the filament can be smoothly fed from the feed tube 101 toward the feed gear 4.

In some embodiments of the present disclosure, by providing the plurality of petal-like segments which splay outwardly and are capable of converging centrally, the gripping accuracy and adaptability of the filament feeding device for the FDM numerically controlled 3D printer to the filament are significantly enhanced.

In some embodiments, as shown in FIG. 2 to FIG. 4, the guide assembly 3 is a guide barrel 301. The guide channel 302 is a V-shaped channel disposed along an axial direction (e.g., the direction of the D-D axis) of the guide barrel 301 and adapted to compress the contraction portion 102.

The guide barrel 301 is a cylindrical structure for guiding a movement direction of the filament feeding assembly 1.

In some embodiments, the guide channel 302 is integrally formed in the guide barrel 301 as a V-shaped tapered bore, thereby forming the V-shaped channel. An end of the V-shaped channel with a smaller inner diameter faces toward and is aligned with the filament inlet of the feed gear 4. An end of the V-shaped channel with a larger inner diameter is away from the feed gear 4 and configured to receive the filament feeding assembly 1.

In some embodiments, an angle between an inner wall of the V-shaped channel and the axial direction of the filament feeding assembly 1 is.

In some embodiments, as shown in FIG. 4, when the filament feeding assembly 1 moves downward along the guide channel 302, it is subjected to a compressive force from the inner wall of the V-shaped channel. The further the filament feeding assembly 1 moves into the V-shaped channel, the smaller the inner diameter of the V-shaped channel becomes, thereby applying a radial pressure to the outwardly splayed petal-like segments.

In some embodiments of the present disclosure, by arranging the V-shaped channel axially within the guide barrel, the guide barrel can guide the filament feeding assembly 1 while simultaneously causing the filament feeding assembly 1 to contract and grip the filament. This configuration ensures stability during the filament feeding process and simplifies the structure of the filament feeding device.

In some embodiments, as shown in FIG. 2 to FIG. 3, a base 304 is provided at a bottom of the guide barrel 301. An adjustment assembly (not shown in the drawings) for adjusting a feed length is provided between the base 304 and the feed tube 101.

In some embodiments, the base 304 is fixedly installed on a side of the filament inlet of the print head 5, and the base 304 is communicably connected in correspondence with the filament inlet.

The feed length refers to a length of the filament that needs to be delivered by the filament feeding assembly.

In some embodiments, an adjustment range of the feed length may be set as required. For example, the adjustment range of the feed length is 4 mm to 12 mm. In some embodiments, the adjustment range of the feed length is 4 mm to 7 mm, 7 mm to 10 mm, or 10 mm to 12 mm.

The adjustment assembly refers to an assembly for adjusting the feed length of the filament. In some embodiments, the adjustment assembly is disposed between the base 304 and the feed tube 101.

In some embodiments, the adjustment assembly may adjust the feed length through various manners. For example, the adjustment assembly may include a set of removable shims or spacers. By inserting or removing shims of different thicknesses between the base and the feed tube, an effective length of the feed tube can be precisely adjusted, thereby adjusting the feed length. In another example, the adjustment assembly may integrate a programmable micro-stepping motor, which finely adjusts the effective length of the feed tube by precisely controlling the count of steps of the stepper motor, thereby achieving adjustment of the feed length. In some embodiments, the adjustment assembly may also adjust the feed length via other feasible manners.

In some embodiments of the present disclosure, distances between the filament inlet of different print heads 5 and the feed gear 4 may vary. Through the base and the adjustment assembly, the feed length can be controlled, enabling the filament feeding device to match different print heads 5 and complete filament feeding from the filament inlet to the feed gear 4, thereby increasing the applicability of the filament feeding device.

In some embodiments, as shown in FIG. 2 to FIG. 4, the adjustment assembly includes a guide sleeve 303, a damping adjustment ring 305, and an elastic compression member 306. The guide sleeve 303 is fixed to the base 304. The damping adjustment ring 305 is movably sleeved on the feed tube 101, and configured to be lockable at different positions on the feed tube 101. The elastic compression member 306 is sleeved on the feed tube between the guide sleeve 303 and the damping adjustment ring 305.

The guide sleeve 303 refers to a rigid short sleeve for guiding a movement direction of the feed tube 101. In some embodiments, the guide sleeve 303 may be fixed to the base 304 through various manners, e.g., adhesion, threaded connection, integral forming, etc. In some embodiments, the guide sleeve 303 is coaxial with and communicably connected to the filament feed port. An inner diameter of the guide sleeve 303 is larger than an outer diameter of the feed tube 101, such that a bottom portion of the feed tube 101 can be inserted into the guide sleeve 303.

The damping adjustment ring 305 refers to an annular or sleeve-like structure configured to adjust a damping force or a compressive force applied to the feed tube 101. The damping adjustment ring 305 may be moved along the feed tube 101 and then fixed in position.

In some embodiments, the damping adjustment ring 305 may be locked at different positions on the feed tube 101 in various manners. For example, an inner diameter of the damping adjustment ring 305 may be slightly smaller than the outer diameter of the feed tube 101. By applying an external force, the damping adjustment ring 305 may be slid along the feed tube 101 to a target position. After the external force is removed, the damping adjustment ring 305 is locked in place through an interference fit. As another example, the damping adjustment ring may be a cam-locking mechanism or a lever-actuated gripping mechanism. By rotating the cam or pressing the lever, an internal structure of the damping adjustment ring grips the feed tube, thereby locking the damping adjustment ring 305 at different positions on the feed tube 101. In some embodiments, the damping adjustment ring 305 may also be locked at different positions on the feed tube 101 through any other feasible manners.

In some embodiments, the damping adjustment ring 305 may be threadedly connected to the feed tube 101.

In some embodiments, an outer wall of the feed tube 101 is provided with an external thread, and an inner wall of the damping adjustment ring 305 is provided with an internal thread matching the external thread. By rotating the feed tube 101, a position of the damping adjustment ring 305 on the feed tube 101 is adjusted.

In some embodiments of the present disclosure, adjustment accuracy can be improved via the threaded connection between the damping adjustment ring 305 and the feed tube 101. Furthermore, the position of the damping adjustment ring can be adjusted by rotation, which is convenient to operate.

The elastic compression member 306 refers to a component capable of deforming along the axial direction (e.g., the direction of the axis D-D) under an external force. For example, the elastic compression member 306 may be a spring, an elastic rubber ring, or the like.

In some embodiments, a range of the feed length of the filament is adjusted by the damping adjustment ring 305, the guide sleeve 303, and the elastic compression member 306. The damping adjustment ring 305 is screwed to different positions on the feed tube 101, thereby adjusting a variable compression amount of the elastic compression member 306 (the spring). Under a pushing action of the pushing assembly 2, the filament feeding assembly 1 moves along the axial direction (e.g., the direction of the axis D-D) towards the feed gear 4, driving the damping adjustment ring 305 to move towards a direction close to the guide sleeve 303, thereby applying pressure to the elastic compression member 306 such that the elastic compression member 306 is compressed towards the direction close to the guide sleeve 303. The maximum compression limit of the elastic compression member 306 corresponds to the maximum value of the feed length. By changing a spacing between the guide sleeve 303 and the damping adjustment ring 305, the feed length of the 3D printing filament is adjusted.

In some embodiments of the present disclosure, through cooperation of the guide sleeve, the lockable damping adjustment ring, and the elastic compression member, precise adjustment of the feed length is achieved. Meanwhile, after the feeding process is complete, the filament feeding assembly can reset under the action of the elastic compression member, thereby achieving automatic filament retraction.

In some embodiments, the pushing assembly 2 includes an automatic telescoping member 201 and a pressure-bearing cover 202. The pressure-bearing cover 202 is engaged between the automatic telescoping member 201 and the filament feeding assembly 1.

The automatic telescoping member 201 refers to a member capable of telescoping along the axial direction (e.g., the direction of the axis D-D) and is configured to drive the filament feeding assembly 1 to move. For example, the automatic telescoping member 201 may be a telescoping rod driven by a spring, a cylinder, a stepper motor, etc. In some embodiments, the automatic telescoping member 201 is fixedly connected to the pressure-bearing cover 202.

In some embodiments, the automatic telescoping member 201 is capable of automatically changing its stroke under the drive of an operation signal, thereby automatically pushing the filament feeding assembly 1 to actively feed the filament toward the feed gear 4.

In some embodiments, the automatic telescoping member 201 may be an electric actuator. An electric actuator is a type of electric executive mechanism, composed of a motor, an actuator rod, and a control device, among other mechanisms, forming a linear executive mechanism capable of achieving remote control and centralized control. The electric actuator is capable of performing reciprocating motion along the axial direction (e.g., the direction of the axis D-D) within a certain stroke range. Using the electric actuator as the executive mechanism not only reduces the air source equipment and auxiliary devices required for pneumatic executive mechanisms but also reduces the weight of the executive mechanism itself. Furthermore, a pneumatic executive mechanism requires a certain air pressure throughout the entire control operation cycle. Although amplifiers with low consumption can be used, the cumulative air consumption over time remains significant. In contrast, for the electric actuator, power is required only when changing the control opening; once the desired opening is reached, no further power is needed. Therefore, from an energy conservation perspective, the electric actuator has significant advantages over pneumatic executive mechanisms.

In some embodiments, an encoder may be additionally installed on the electric actuator. The encoder accurately feeds back the count of rotations of a motor spindle via pulse counts, thereby allowing precise calculation of the stroke variation of the electric actuator and enabling precise control.

The pressure-bearing cover 202 is configured to transmit the motion of the automatic telescoping member 201 to the filament feeding assembly 1. The pressure-bearing cover 202 may be a component with a curved surface or a groove to increase a contact area between the pressure-bearing cover 202 and the filament feeding assembly 1.

In some embodiments, an engagement portion is integrally formed at an end of the pressure-bearing cover 202 close to the automatic telescoping member 201, and the engagement portion is fixedly connected to the automatic telescoping member 201. A surface of the pressure-bearing cover 202 facing the filament feeding assembly 1 is in tight contact with the filament feeding assembly 1.

In some embodiments of the present disclosure, active filament feeding is achieved through the automatic telescoping member 201. The pressure-bearing cover 202 increases the contact area between the pushing assembly and the filament feeding assembly 1, thereby facilitating the pushing of the filament feeding assembly 1.

In some embodiments, the pressure-bearing cover 202 is provided with a receiving groove, and the filament feeding assembly 1 is provided with a receiving boss 103 matching the receiving groove. The receiving boss 103 is arranged within the receiving groove.

The receiving groove refers to a groove on the pressure-bearing cover 202 for accommodating and fixing the filament feeding assembly 1. The receiving boss 103 refers to a protruding member on the filament feeding assembly 1 that cooperates with the receiving groove. In some embodiments, the receiving groove is located on a bottom surface of the pressure-bearing cover 202 close to the filament feeding assembly 1. The petal-like segments of the filament feeding assembly 1 are integrally formed with the receiving boss 103, and the receiving boss 103 is interference-fitted with the receiving groove. A pushing force generated when the automatic telescoping member 201 extends is transferred to the filament feeding assembly 1 through the pressure-bearing cover 202, causing the filament feeding assembly 1 to feed the filament along the axial direction (e.g., the direction of the axis D-D) towards the feed gear 4.

In some embodiments of the present disclosure, by providing the receiving groove on the pressure-bearing cover and providing the matching receiving boss on the filament feeding assembly, precise and rapid positioning and a stable connection between the filament feeding assembly and the pressure-bearing cover are achieved. This structure effectively simplifies installation and disassembly processes of the filament feeding assembly, significantly reducing operation time. Furthermore, the tight cooperation between the receiving groove and the receiving boss enhances the anti-vibration and anti-displacement capability of the filament feeding assembly during operation, improves the stability and precision of filament feeding, and thereby increases the reliability of the filament feeding device.

Some embodiments of the present disclosure provide a fully automatic filament feeding method for a Fused Deposition Modeling (FDM) numerically controlled three-dimensional (3D) printer (also referred to as a filament feeding method for the FDM numerically controlled 3D printer), based on the filament feeding device for an FDM numerically controlled 3D printer described in one or more embodiments of the present disclosure. The method comprises: executing, by a system, a zero reset operation for a workpiece coordinate system, and returning a filament feeding axis to a reference point; controlling the pushing assembly of the filament feeding device to push the filament feeding assembly to move and grip the filament, and feeding the filament toward the feed gear.

More descriptions regarding the filament feeding device, the pushing assembly, the filament feeding assembly, the filament, and the feed gear may be found in FIG. 1 to FIG. 5 and related descriptions thereof.

The system may be a numerical control system for executing the fully automatic filament feeding method for an FDM numerically controlled 3D printer. In some embodiments, the system includes a processor. The processor may include one of a microcontroller (MCU), an embedded processor, a graphics processing unit (GPU), or the like, or any combination thereof.

The workpiece coordinate system is a coordinate system established in the numerical control system for convenient programming and machining, with its origin (e.g., a reference point) set at a specific point on a workpiece. The zero reset operation resets a value of the workpiece coordinate system to an initial state.

The reference point is a preset point in the numerical control system used for positioning all movements. Before startup or a specific operation, the numerical control system returns to the reference point to ensure precise positioning.

The filament feeding axis is a mechanical axis in the printer that controls a feeding direction and a feeding speed of the filament.

In some embodiments, the system performs the zero reset operation for the workpiece coordinate system by sending a zero reset command to the filament feeding axis, resetting a current position value of each axis in the printer to zero, thereby providing a unified benchmark for subsequent filament feeding.

In some embodiments, the system controls a motor parameter of the automatic telescoping member to push the filament feeding assembly to move, causing the filament feeding assembly to move from an initial position to a gripping position where the filament is aligned with the feed gear. The motor parameter may be preset according to requirements.

In some embodiments, after the filament is aligned with the feed gear, the system drives a motor of the feed gear to rotate, causing the feed gear to engage with the filament and feed the filament to the printing nozzle. A rotational speed of the motor of the feed gear may be preset according to requirements.

In some embodiments, a distance between the damping adjustment ring 305 and the guide sleeve 303 is adjusted such that an adjustment range of the feed length satisfies a preset length range. The preset length range may be set according to requirements. For example, the preset length range may be 4 mm to 12 mm.

In some embodiments, the system executes a new numerical control (NC) program. Based on the design of the filament feeding device, the new NC program incorporates an automatic filament feeding command into the original program. The automatic filament feeding command is an instruction that provides an execution signal to the automatic telescoping member 201 to enable the automatic telescoping member 201 to complete a pushing action. Merely by way of example, the code of the new NC program may be:
G0 F4800 X97.644 Y124.385
G1 F6000 A10004//A-axis value before the zero reset operation G92 A0 G28 A0//When the feed length reaches a set reset value, the machine coordinate system where the A-axis is located automatically performs a return to reference point operation M82//Automatic filament feeding device actuation command
G1 F2100 X101 Y120 A0.13072//A-axis value after the zero reset operation
G1 X101.492 Y120.821 A0.13575.

In some embodiments, after the numerical control system executes a complete zero reset operation for the workpiece coordinate system and the A-axis (filament feeding axis) automatically returns to the reference point via the “G92 A0 G28 A0” command, the automatic filament feeding device begins to execute the “M82” automatic filament feeding command from the numerical control system. After receiving the command, the automatic telescoping member 201 (i.e., an electric actuator) extends to drive the pressure-bearing cover 202 to generate a downward force (in a direction towards the feed gear 4) on the filament feeding assembly 1. After being subjected to the downward force, the filament feeding assembly 1 tends to move downward. At this time, the V-shaped guide channel 302 provided on the inner wall of the guide barrel 301 applies a radial force to the filament feeding assembly 1, causing it to contract and drive the filament with a diameter of 1.75 mm to 3.0 mm to move downward, as shown in FIG. 4. Restricted by the direction of the guide sleeve 303, the filament passes directionally and uniformly through the guide barrel 301, and is delivered from the base 304 and through the filament inlet to the feed gear 4. The system can control, based on the NC commands, the feed gear 4 to engage with the filament and complete the filament feeding operation, as shown in FIG. 5.

The automatic filament feeding method provided by the embodiments of the present disclosure may be understood as follows. Based on the automatic filament feeding device and in conjunction with a specific M-code during the operation of the FDM numerically controlled 3D printer, the device performs filament feeding. Specifically, the pressure-bearing cover 202, under the action of the automatic telescoping member 201 (i.e., the electric actuator), applies a force to the feed tube 101. During its downward movement, the feed tube 101 is subjected to a radial pressure from the V-shaped guide channel 302 on the inner wall of the guide barrel 301. This causes the contraction portion 102 to contract radially, driving a 3D printing linear filament with a diameter ranging from 1.75 mm to 3.0 mm to move downward, thereby completing the filament feeding action. Each time the numerical control system performs the zero reset operation, the 3D printing filament retracts to the filament inlet. The M-code then controls the pushing assembly to push the filament feeding assembly 1 to actively feed the filament from the filament inlet toward the feed gear 4. This prevents the occurrence of the “idling phenomenon” in the next printing round, thus thoroughly resolving the issue of feed gear 4 idling during the operation of the FDM numerically controlled 3D printer.

The fully automatic filament feeding method for an FDM numerically controlled 3D printer, provided by the embodiments of the present disclosure, operates in conjunction with a specific program code during the execution of the FDM numerically controlled 3D printer's program. After the zero reset operation for the workpiece coordinate system is completed, the system operation causes the pushing assembly to automatically push the filament feeding assembly to grip the filament and actively feed it toward the feed gear. This approach achieves infinite filament feeding by the filament feeding axis, prevents the occurrence of the “idling phenomenon,” and consequently, based on the success of infinite filament feeding, enables the printing of ultra-large-scale aviation components.

The basic concepts have been described above. Obviously, to those skilled in the art, the above detailed disclosure is merely an example and does not constitute a limitation to the present disclosure. Although not explicitly stated herein, those skilled in the art may make various modifications, improvements, and amendments to the present disclosure. Such modifications, improvements, and amendments are suggested in the present disclosure, so they still fall within the spirit and scope of the exemplary embodiments of the present disclosure.

Meanwhile, the present disclosure uses specific words to describe the embodiments of the present disclosure. For example, “one embodiment”, “an embodiment”, and/or “some embodiments” mean that a certain feature, structure, or characteristic is related to at least one embodiment of the present disclosure. Therefore, it should be emphasized and noted that “an embodiment” or “one embodiment” or “an alternative embodiment” mentioned two or more times in different locations in the present disclosure does not necessarily refer to the same embodiment. Furthermore, certain features, structures, or characteristics in one or more embodiments of the present disclosure can be combined appropriately.

Furthermore, the order of processing elements and sequences, the use of numbers and letters, or the use of other names in the present disclosure are not intended to limit the order of the processes and methods of the present disclosure. Although the above disclosure discusses some inventive embodiments currently considered useful through various examples, it should be understood that such details are for illustrative purposes only. For example, although the implementation of various components described above may be embodied in a hardware device, it may also be implemented as a software only solution, e.g., an installation on an existing server or mobile device.

Similarly, it should be noted that, in order to simplify the expression disclosed in the present disclosure and thereby help the understanding of one or more inventive embodiments, multiple features are sometimes grouped into one embodiment, drawing, or description thereof in the foregoing description of the embodiments of the present disclosure. Rather, claimed subject matter may lie in less than all features of a single foregoing disclosed embodiment.

In some embodiments, numbers describing components and property quantities are used. It should be understood that such numbers used to describe the embodiments are modified by the modifiers “approximately”, “about”, or “substantially” in some examples. Unless otherwise stated, “approximately”, “about”, or “substantially” indicates that the stated number allows a variation of ±20%. Accordingly, in some embodiments, the numerical parameters used in the specification are all approximate values, which may vary according to the characteristics required by individual embodiments. In some embodiments, numerical parameters should consider the specified number of significant digits and adopt the method of general digit retention. Although the numerical ranges and parameters used to confirm the breadth of the scope in some embodiments of the present disclosure are approximate values, in specific embodiments, the setting of such numerical values is as precise as possible within the feasible range.

For each patent, patent application, patent application publication, and other materials, such as articles, books, specifications, publications, documents, etc., cited in the present disclosure, the entire contents thereof are hereby incorporated into the present disclosure by reference. Except for application history documents that are inconsistent with or conflict with the content of the present disclosure, and also except for documents that limit the broadest scope of the present disclosure (currently or subsequently appended to the present disclosure). It should be noted that if the description, definition, and/or use of terms in the ancillary materials of the present disclosure are inconsistent with or conflict with the content described in the present disclosure, the description, definition, and/or use of terms in the present disclosure shall prevail.

Finally, it should be understood that the embodiments described in the present disclosure are only used to illustrate the principles of the embodiments of the present disclosure. Other variations may also fall within the scope of the present disclosure. Therefore, by way of example and not limitation, alternative configurations of the embodiments of the present disclosure can be considered consistent with the teachings of the present disclosure. Accordingly, the embodiments of the present disclosure are not limited to the embodiments explicitly introduced and described in the present disclosure.

What is claimed is:

1. A filament feeding device for a Fused Deposition Modeling (FDM) numerically controlled three-dimensional (3D) printer, comprising:
a filament feeding assembly, configured to expand and contract in a radial direction of the filament feeding assembly to grip and release a filament passing axially through the filament feeding assembly;
a guide assembly, wherein the guide assembly is provided with a guide channel along an axial direction of the guide assembly, the filament feeding assembly is movably provided within the guide channel, and during a movement of the filament feeding assembly along the guide assembly, the guide channel is configured to apply a radial pressure to the filament feeding assembly;
a pushing assembly, configured to push the filament feeding assembly to move along the guide channel so as to deliver the filament to a feed gear; and
the feed gear, configured to convey the filament to a printing nozzle.

2. The filament feeding device for the FDM numerically controlled 3D printer according to claim 1, wherein the filament feeding assembly includes a feed tube and a contraction portion integrally formed at a terminal end of the feed tube, the contraction portion is configured to, when subjected to a compressive force, grip the filament passing axially through the feed tube.

3. The filament feeding device for the FDM numerically controlled 3D printer according to claim 2, wherein the contraction portion includes a plurality of petal-like segments which splay outwardly and are capable of converging centrally.

4. The filament feeding device for the FDM numerically controlled 3D printer according to claim 2, wherein the guide assembly is a guide barrel, and the guide channel is a V-shaped channel provided along an axial direction of the guide barrel and adapted to compress the contraction portion.

5. The filament feeding device for the FDM numerically controlled 3D printer according to claim 4, wherein a base is provided at a bottom of the guide barrel, and an adjustment assembly for adjusting a feed length is provided between the base and the feed tube.

6. The filament feeding device for the FDM numerically controlled 3D printer according to claim 5, wherein the adjustment assembly includes:
a guide sleeve fixed to the base;
a damping adjustment ring movably sleeved on the feed tube, and configured to be lockable at different positions on the feed tube; and
an elastic compression member sleeved on the feed tube between the guide sleeve and the damping adjustment ring.

7. The filament feeding device for the FDM numerically controlled 3D printer according to claim 6, wherein the damping adjustment ring is threadedly connected to the feed tube.

8. The filament feeding device for the FDM numerically controlled 3D printer according to claim 1, wherein the pushing assembly includes an automatic telescoping member and a pressure-bearing cover, and the pressure-bearing cover is engaged between the automatic telescoping member and the filament feeding assembly.

9. The filament feeding device for the FDM numerically controlled 3D printer according to claim 8, wherein the pressure-bearing cover is provided with a receiving groove, the filament feeding assembly is provided with a receiving boss matching the receiving groove, and the receiving boss is arranged within the receiving groove.

10. A fully automatic filament feeding method for an FDM numerically controlled 3D printer, being based on the filament feeding device for the FDM numerically controlled 3D printer according to claim 1, the method comprising:
executing, by a system, a zero reset operation for a workpiece coordinate system and returning a filament feeding axis to a reference point; and
controlling the pushing assembly to push the filament feeding assembly to move and grip the filament, and feeding the filament toward the feed gear.
